(19) United States
(12) Patent Application Publication
(10) Pub. No.: US 2009/0106683 A1
(43) Pub. Date: Apr. 23, 2009

(54) Method of Simulating Operations of Products

(76) Inventor: Ya-Ran Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/876,773

(22) Filed: Oct. 23, 2007

(51) Int. Cl. G06F 3/048; G06F 15/16; G06F 17/30

(52) U.S. Cl. 715/771

(57) ABSTRACT

For solving communication hazards generated by lacking objects of products while technical problems of the products are discussed between customer service providers and customers, or between customer service providers and technical support providers, and for saving room for depositing the objects of various products, an application program, which includes a plurality of user interface simulation programs corresponding to a plurality of products, is provided for the customer service providers. With the aid of the provided application program, when the customer service providers communicate technical problems of products of various types with others, a corresponding user interface simulation program is called for simulating solutions provided by the technical support providers, or for providing the solutions for the customers in detail.

### BACKGROUND OF THE INVENTION

1. Field of the Invention

The present invention relates to a simulation method, and more particularly, to a method of simulating operations of products.

2. Description of the Prior Art

When unknown malfunctions or modulation failures occur in an electronic product, since a conventional consumer lacks repair knowledge of the electronic product, the consumer may ask customer service providers where the electronic product was bought for help to acquire aid in repair. Moreover, even if a user manual is available for the user, the electronic product may not be repaired to an acceptable state, and therefore, the customer still needs to ask the customer service providers for help. However, since there are a various types of electronic products, the customer service providers may not be able to learn entire details about the specifications, operations, and repair of each type of products at any time and give timely help to consumers. Therefore, when a conventional customer service provider meets unsure circumstances, he or she may still need to communicate with skillful engineers to ask for help. During such communications, since the customer service provider may not have an object of the required type of product, the customer service provider may not be able to fully understand instructions from the engineer to report to the customer so that misunderstandings occur. Even if the customer service provider has objects of all types of electronic products at hand, room required for depositing the objects must be huge. For a customer service provider required to provide services of a various types of electronic products, he or she may easily take one thing into consideration to neglect the other. Moreover, the customer service provider may not have sufficient space for depositing the objects to meet requirements of customers in repair of various types of electronic products.

Besides, in job trainings related to various types of products and with engineers or customer service providers, in spite of restrictions of foundations or space, sometimes not each educated engineer or customer service provider has an object of related type of product. Under job trainings without objects of related products, performances of job trainings are reduced significantly. It also implicitly damages in establishing and popularizing well communications and repair for the company.

### SUMMARY OF THE INVENTION

The claimed invention discloses a method of simulating operations of products. The method comprises establishing a database storing all functions of a plurality of types of products, establishing a user interface simulation program for each type of the plurality of types of products according to stored contents of the established database, providing an application program capable of calling a user interface simulation program corresponding to a chosen type from the plurality of types of the products for a user, and providing an operating procedure according to requests about one type of products and from the user for enabling the user to input the operating procedure into a user interface simulating program corresponding to the type of products. The chosen type is chosen with the aid of the provided application program. The application program stores both a plurality of user interface simulation programs corresponding to each type of the plurality of types of products and the database. Each of the plurality of user interface simulation programs is capable of simulating functions of a corresponding type of products according to an operating procedure inputted by the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of the disclosed method of simulating operations of products in the present invention.

FIG. 2 is a diagram of applying the method shown in FIG. 1 on repair of a monitor.

FIG. 3 and FIG. 4 are diagrams of the user interface simulation program illustrated in FIG. 2 while the user interface simulation program is utilized for simulating operations of a monitor according to the method shown in FIG. 1.

### DETAILED DESCRIPTION

For solving the problems of communication disturbances or huge room related to various types of products in product repair and job trainings, a method of simulating operations of products is disclosed in the present invention for solving the abovementioned problems.

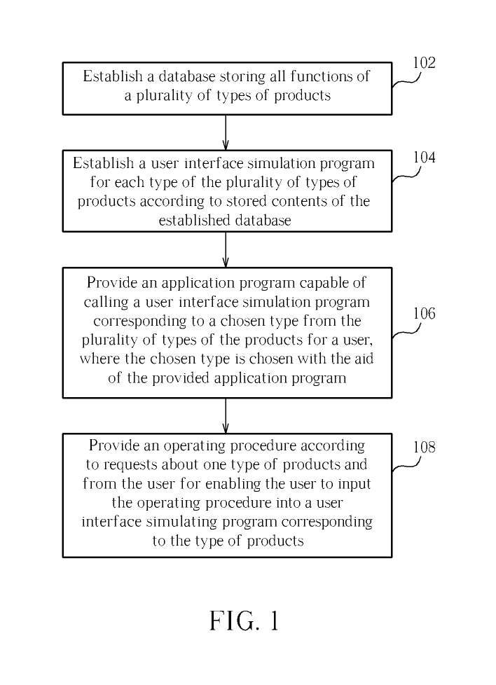

Please refer to FIG. 1, which is a flowchart of the disclosed method of simulating operations of products in the present invention. The disclosed method of the present invention includes steps as follows:

Step 102: Establish a database storing all functions of a plurality of types of products.

Step 104: Establish a user interface simulation program for each type of the plurality of types of products according to stored contents of the established database.

Step 106: Provide an application program capable of calling a user interface simulation program corresponding to a chosen type from the plurality of types of the products for a user, where the chosen type is chosen with the aid of the provided application program.

Step 108: Provide an operating procedure according to requests about one type of products and from the user for enabling the user to input the operating procedure into a user interface simulating program corresponding to the type of products.

The disclosed method of simulating operations of products in the present invention is primarily applied on consumer electronic products equipped with at least one displaying device, such as televisions, cell phones equipped with monitors, personal digital assistants, and laptops. Therefore, the hereafter disclosed embodiments of the present invention are based on consumer electronic products equipped with at least one displaying device, such as a monitor. However, other embodiments formed by applying the disclosed method of the present invention on products other than consumer electronic products should also be embodiments of the present invention.

In the disclosed method of simulating operations of products in the present invention, a user interface simulation program is respectively established in advance for each corresponding type of products, and all the established user interface simulation programs are unified as an application program. Each user interface simulation program is designed to be capable of simulating entire functions and effects of a corresponding type of products, where the simulated functions and effects are originally displayed with a user interface of the type of products on a displaying device. For example, when the method of the present invention is applied on a monitor, a user interface simulation program provided according to the method of the present invention is designed to be capable of simulating all functions of a user interface on the monitor, such as contrast and brightness. Moreover, performances related to any operations upon the user interface are also entirely displayed while the same operations are triggered on the user interface simulation program.

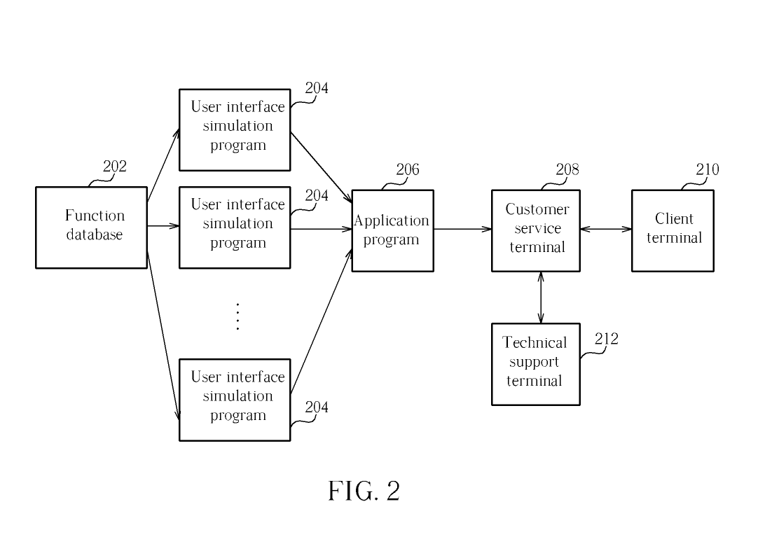

Please refer to FIG. 2, which is a diagram of applying the method shown in FIG. 1 on repair of a monitor. As shown in both Step 102 and FIG. 2, a function database 202 stores all functions of a plurality of types of monitors. According to descriptions of Step 104, each of a plurality of user interface simulation programs 204 corresponds to a different type of monitors, and is established by fetching functions of a corresponding type of monitors from the function database 202. According to descriptions of Step 106, an application program 206 unifies a plurality of user interface simulation programs 204 established in Step 104. The application program 206 is capable of calling a specific user interface simulation program 204 according to an externally inputted type of monitors. In conventional communications about repair of a monitor, a customer at a client terminal 210 issues repair requirements about a specific type of monitors towards a customer service provider at the customer service terminal 208, and then the customer service provider responds the customer with a corresponding solution. When the customer service provider meets repair requirements without an available solution himself or herself, the customer service provider requests technical staffs or engineers at the technical support terminal 212 for the available solution. Note that communications between the customer service terminal 208, the client terminal 210, and the technical support terminal 212 include first-hand conversations or telecommunications with networks and telephones in a synchronous or asynchronous manner. In other words, relative locations between the customer service terminal 208, the client terminal 210, and the technical support terminal 212 may be same locations or remote locations. Communications between the locations may be synchronous communications or asynchronous communications. Observed from descriptions of the prior art, without objects of the required type of monitors, communications between the customer service terminal 208 and the technical support terminal 212 may fail. When there is no sufficient room for depositing objects of all required types of monitors, technical supports about all types of monitors cannot be successfully provided. Therefore, while the method disclosed in FIG. 1 is applied on the communications for repairing monitors, the application program 206 is installed on the customer service terminal 208 to relieve the abovementioned problems. The customer service provider at the customer service terminal 208 calls a required user interface simulation program 204 with the aid of the application program 206 according to a provided type of monitors from a customer at the client terminal 210, and operates the called user interface simulation program 204 according to repair requirements from the customer for looking for an available solution. When the customer service provider finds the available solution to come out with an operation procedure, which includes a plurality of consecutive steps, the customer service provider is able to demonstrate the consecutive steps one by one to the customer with the aid of synchronous operations on both the user interface simulation program 204 at the customer service terminal 208 and the object at the client terminal 210 so that the customer is effectively taught with the available solution without communication disturbances. Under such condition, the user described in both Step 106 and Step 108 is exactly the customer at the client terminal 210, and the operation procedure described in Step 108 is implicitly indicated by the available solution.

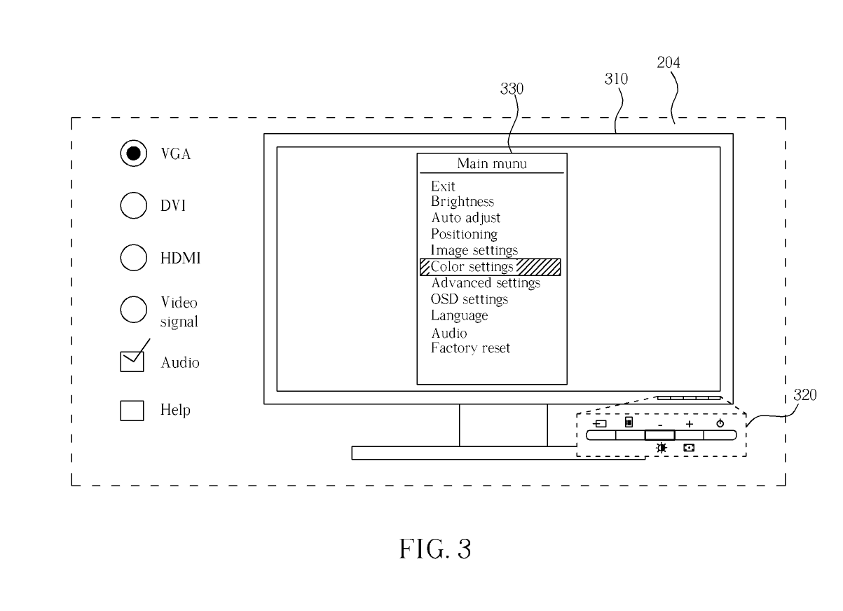

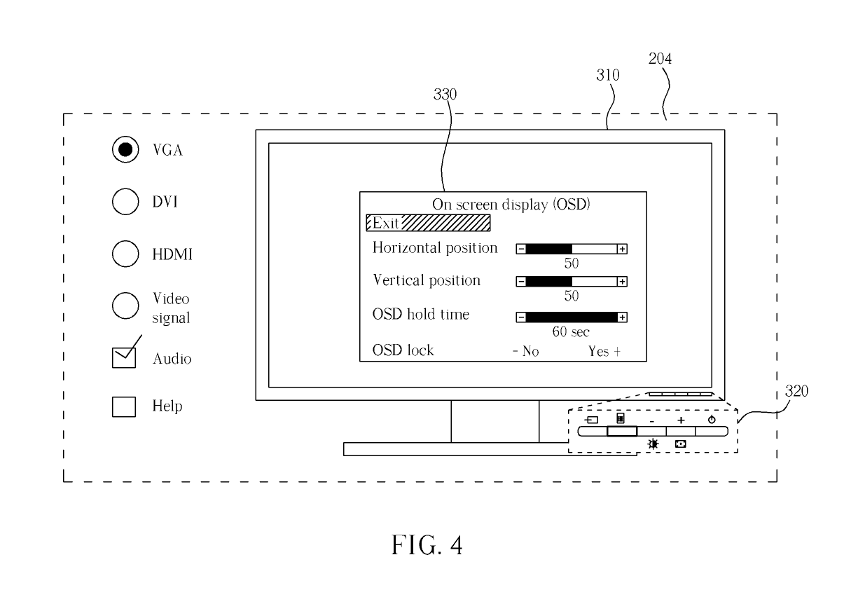

Please refer to FIG. 3 and FIG. 4, both of which are diagrams of the user interface simulation program 204 illustrated in FIG. 2 while the user interface simulation program 204 is utilized for simulating operations of a monitor according to the method shown in FIG. 1. As shown in FIG. 3, a main menu on a user interface simulation program 204, which is displayed on a virtual screen 310, is utilized for instructing a user to operate simulated functions of the monitor in forms of a hierarchical category 330, where the simulated functions include brightness, auto adjust, positioning, image settings, color settings, advanced settings, on-screen display (OSD) settings, language, audio, and factory reset. A virtual panel 320 is also provided on the user interface simulation program 204 for activating the simulated functions. As shown in FIG. 3, note that activate messages including video graphics array (VGA), digital visual interface (DVI), high definition multimedia interface (HDMI), video signal, audio, and help, may also be displayed on the user interface simulation program 204 to inform the user with current-activated functions on the user interface simulation program 204. When a user activates the on-screen settings function on the virtual panel, as shown in FIG. 4, the user interface simulation program 204 also instructs the user how to activate simulated functions including horizontal position, vertical position, OSD hold time, and OSD lock on the hierarchical category 330. The user interface simulation program 204 utilizes a same panel as an object of the corresponding type of monitor to enable the user to user the simulated functions in a visual manner. The simulated functions have been acquired by conventional monitors so that the simulated functions are not further discussed. Note that in a preferred embodiment of the present invention, the application program 206 may also instruct the user on feasible simulated functions with the hierarchical category 330, where the simulated functions include choosing a specific type of monitors to call a corresponding user interface simulation program 204, which are then operated in a same manner as the abovementioned descriptions.

In a preferred embodiment of the present invention, the customer service terminal 208, the client terminal 210, and the technical support terminal 212 are separated at different remote locations. When a customer service provider at the customer service terminal 208 cannot find an available solution, he or she may communicate with technical staffs or engineers at the remote technical support terminal 212 to follow instructions step by step so as to fully understand the available solution. At last, the customer service provider provides the available solution for the customer according to the descriptions disclosed in FIG. 2 to eliminate any possible communication disturbances. In the preferred embodiment of the present invention, the user described in Step 106 and Step 108 is exactly the customer service provider at the customer service terminal 208, and the technical staffs and engineers at the remote technical support terminal 212 are assumed to have objects of the required type of monitor or be installed with the application program 206. However, in another preferred embodiment of the present invention, the technical support terminal 212 is supposed to merely be installed with the application program 206, i.e., there are no objects of the required type of monitors at the technical support terminal, since the required type of monitors may have been ceased in production at the technical support terminal 212.

Since the instructions or steps in the provided available solution according to the method shown in FIG. 2 are used instructions or steps in conventional monitors, details of the instructions or steps are not discussed further. However, using uncommon instructions or steps of monitors should not be limitations to the present invention.

According to descriptions in FIG. 1 and FIG. 2, after implementing the disclosed method of the present invention, objects of various types of monitors are no longer required to be deposited at the technical support terminal 212 and the customer terminal 208. Instead, merely the application program 206 is required to be installed at both the technical support terminal 212 and the customer 208 so that huge room for depositing objects of various types of monitors is saved. Moreover, with the aid of the remote synchronous communications between the customer service terminal 208 and the client terminal 210, or between the customer service terminal 208 and the technical support terminal 212, steps in the operation procedures may be exactly consistent so that communication disturbances are entirely prevented to shorten time for communications.

The disclosed method of the present invention may also be applied on job trainings. By packaging the application program into an electronic manual, a user of the electronic manual may just use the electronic manual to obtain the available solution or to practice operations of products by operating a required user interface simulation program 204. That is, the electronic manual may be regarded as a specific preferred embodiment of the present invention when the customer service terminal 208, the client terminal 210, and the technical support terminal 212 are at a same location. Note that the user of the electronic manual may just input keywords into the electronic manual so as to communicate with the electronic manual in a synchronous or asynchronous manner, and to retrieve a required solution for a specific type of products. The electronic manual may also be directly provided for the customer at the client terminal 210 to perform interactive simulations for saving time to consult with the customer service provider at the customer service terminal 208.

According to the method of simulating operations of products in the present invention, communication disturbances between customer service providers and customers, or between customer service providers and technical support providers, may be effectively eliminated, where the communication disturbances are resulted from lacks in objects of various types of products. With the aid of the disclosed method of the present invention, huge room for depositing various types of products to enhance communications is also saved while repair requirements of the various types of products are issued.

Those skilled in the art will readily observe that numerous modifications and alterations of the device and method may be made while retaining the teachings of the invention.

What is claimed is:

1. A method of simulating operations of products comprising:
establishing a database storing all functions of a plurality of types of products;
establishing a user interface simulation program for each type of the plurality of types of products according to stored contents of the established database;
providing an application program capable of calling a user interface simulation program corresponding to a chosen type from the plurality of types of the products for a user, wherein the chosen type is chosen with the aid of the provided application program; and
providing an operating procedure according to requests about one type of products and from the user for enabling the user to input the operating procedure into a user interface simulating program corresponding to the type of products;
wherein the application program stores both a plurality of user interface simulation programs corresponding to each type of the plurality of types of products and the database;
wherein each of the plurality of user interface simulation programs is capable of simulating functions of a corresponding type of products according to an operating procedure inputted by the user.

2. The method of claim 1 wherein the plurality of types of products comprises a plurality of types of electronic products, each type of which is equipped with at least one displaying device.

3. The method of claim 2 wherein the plurality of types of products comprises televisions.

4. The method of claim 2 wherein the plurality of types of products comprises cell phones equipped with at least one screen.

5. The method of claim 2 wherein the plurality of types of products comprises monitors.

6. The method of claim 2 wherein the plurality of types of products comprises personal digital assistants.

7. The method of claim 2 wherein the plurality of types of products comprises laptops.

8. The method of claim 1 wherein the operating procedure is provided for a remote user with the aid of networks or telephones.

9. The method of claim 1 wherein the operating procedure is stored in the application program; wherein when the user inputs key words corresponding to the operating procedure into the application program and calls a user interface corresponding to the operating procedure with the aid of the application program, the application program calls and displays the operating procedure for the user.

10. The method of claim 1 wherein each user interface simulation program lists all functions of a corresponding type of products with a hierarchical category.

11. The method of claim 1 wherein the application program lists all types of products with a hierarchical category for enabling a user of the application program to choose a required user interface simulation program with the aid of the application program.

12. The method of claim 1 wherein the operating procedure is provided for the user in a synchronous manner.

13. The method of claim 1 wherein the operating procedure is provided for the user in an asynchronous manner.
